(19) United States
(12) Patent Application Publication
(10) Pub. No.: US 2006/0266167 A1
(43) Pub. Date: Nov. 30, 2006

(54) Multi-coupling adjustable tools

(76) Inventor: Charles A. Cole, Plano, TX (US)

Correspondence Address: Charles A. Cole, 7620 Avalon Drive, Plano, TX, 75025, US

(21) Appl. No.: 11/434,732

(22) Filed: May 16, 2006

Related U.S. Application Data
(60) Provisional application No. 60/682,256, filed on May 18, 2005.

(51) Int. Cl. B25B 7/00

(52) U.S. Cl. 81/300

(57) ABSTRACT

Adjustable tools which may be linked through a plurality of couplings connected by links so that the tool and the handle and the links are rotatable relative to each other in a released condition and locked relative to each other in a locked position. The tool, the handle and the links may thus be adjusted to have the tool at any desired orientation to the handle and in a locked position in that orientation.

### RELATED CASES

This application is entitled to and hereby claims the benefit of the filing date of Provisional Application Ser. No. 60/682,256 filed May 18, 2005 entitled “Multi-Coupling Adjustable Tools” by Charles A. Cole.

### FIELD OF THE INVENTION

The present invention relates to adjustable tools, which may be linked through a plurality of coupling and links so that the tool and the handle are adjustable relative to each other to form a tool which is tailored to access difficulty accessible areas.

### BACKGROUND OF THE INVENTION

Many tools have been proposed which provide for adjustable wrenches. One such tool is shown in U.S. Pat. No. 5,419,221 issued May 30, 1995 to James Cole. This patent discloses a wrench which has a splined pin fixed to the head of the wrench with the handle being moveable between an upper released position and a lower locked position. This wrench has the disadvantage that the pin protrudes for a substantial distance above the wrench in all instances. This patent is hereby incorporated in its entirety by reference.

U.S. Pat. No. 5,775,184 issued Jul. 7, 1998 to James Cole discloses a similar wrench. U.S. Pat. Nos. 5,820,288, 6,000,299 and 6,161,982 also relate to tools which use splined connections in various ways. These patents are further incorporated in their entirety by reference.

Other variations have been proposed which require a smooth pin positioned on the wrench head with the pin being used to engage an opening in the handle which includes flat surfaces moveable into engagement at various positions to lock the wrench and the handle into fixed positions. These wrenches also require that the pin protrude a substantial distance above the top of the wrench.

All of these wrenches are subject to certain shortcomings. Many of the wrenches previously developed to have releasable coupling involve the use of springs so that the wrench may be released only while the pin is held in a particular position from which it returns when released. This results in certain disadvantages, particularly with respect to the protrusion of elements from the sides or tops of the wrenches or the tools. Accordingly, a continued effort has been directed to the development of simpler, more rugged and less protrusive coupling systems for tools.

In particular, all of these wrenches permit the rotation of a tool head, referred to herein primarily as a wrench head, through up to 360 degrees relative to a wrench handle. While this offers many advantages with respect to accessing difficultly reachable bolts and the like, it is found that in some instances bolts are located in areas which cannot be reached, even by the adjustment of the orientation of the wrench head to the handle. Similar considerations apply to pry bars and other tools.

In some instances areas are desirably accessed which are simply beyond the reach of tools which have a rotatable head relative to the handle.

Accordingly, a continuing effort has been directed to the development of tools which can be tailored to a desired configuration to reach difficultly accessible areas for contacting such areas with a tool as required.

### SUMMARY OF THE INVENTION

According to the present invention, an adjustable tool wherein a plurality of couplings and at least one link are positioned between a tool handle and a tool, the tool comprising: a first member connected at a first coupling to a first link so that the first member and the first link may be coupled to be rotatable relative to each other or so that the first member and the first link are locked relative to each other; at least one additional link connected to the first link and at least one second coupling so that the first link and the at least one additional link are coupled to be rotatable relative to each other or so that the first link and the at least one additional link are locked relative to each other; and, a second member connected to a terminal link at a terminal coupling so that the terminal link and the second member are rotatable relative to each other or so that the terminal link and the second member are locked relative to each other.

### BRIEF DESCRIPTION OF THE DRAWINGS

FIG. 1. schematically shows a ratchet wrench, including a multi-coupling according to the present invention;

FIG. 1(a) schematically shows a wrench including a plurality of couplings, according to the present invention;

FIG. 1(b) shows a wrench, including a plurality of couplings which has been tailored to access a difficultly accessible area;

FIG. 2 schematically shows a pry bar having a plurality of couplings;

FIG. 3 is a schematic diagram of a pin, according to the present invention;

FIG. 3(a) is an end view of a first end of the pin of FIG. 3;

FIG. 3(b) is an end view of a second end of the pin shown in FIG. 3;

FIG. 3(c) is a cross-sectional view of an end cap suitable for use on either end of the pin shown in FIG. 3;

FIG. 4 is a schematic cross-sectional diagram of a first member for connection at a coupling of the present invention;

FIG. 5 is a schematic diagram of a mating member for junction to the member shown in FIG. 4;

FIG. 6 is a schematic diagram of the members shown in FIGS. 4 and 5 in combination with the pin in place in a locked position;

FIG. 7 is a schematic diagram of the members of FIGS. 4 and 5 in combination with the pin in a released position;

FIG. 8 shows a link functional to link two couplings; and,

FIG. 9 shows is a top view of the link shown in FIG. 8.

### DESCRIPTION OF PREFERRED EMBODIMENTS

In the discussion of the Figures, the same numbers will be used throughout to refer to the same or similar components.

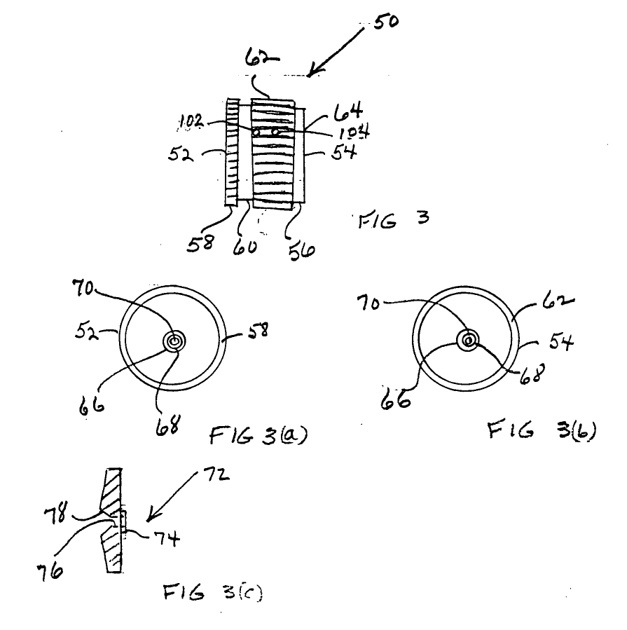

In the practice of the present invention, a large number of coupling systems may be used. For instance, those coupling systems discussed in the Background are useful with the subject invention. It is preferred however that couplings which do not have protruding parts extending beyond the edges of the coupling and couplings which do not require that the coupling be spring released to position a coupling in a releasable position be used. One preferred coupling is shown in FIGS. 3-7.

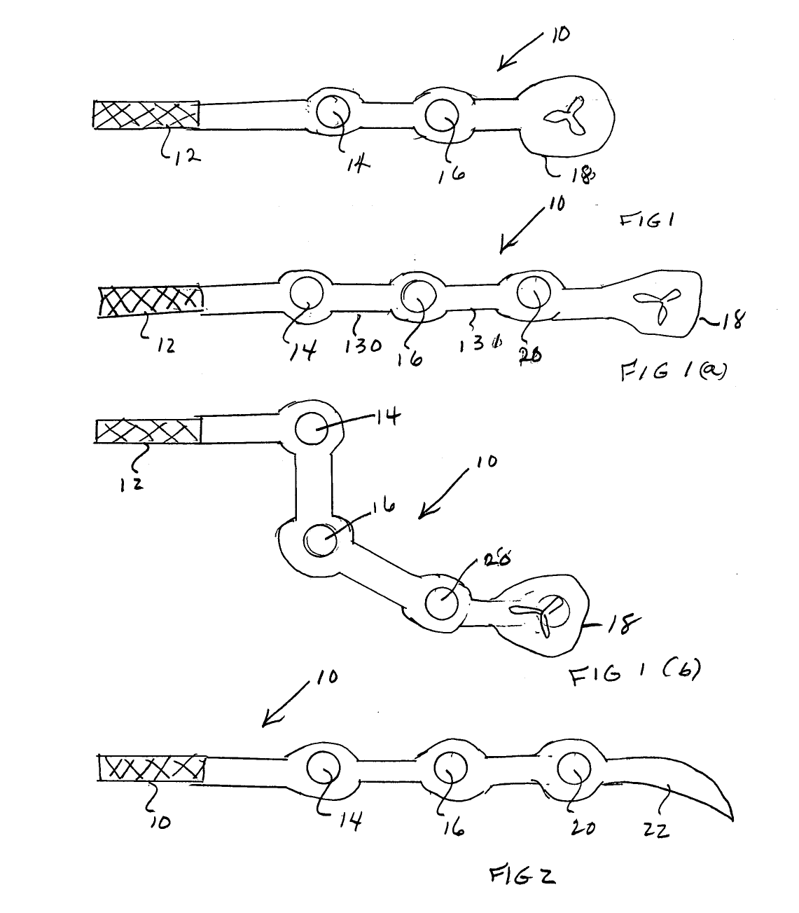

In FIG. 1 an adjustable wrench, according to the present invention, is shown. The wrench comprises a handle 12 having a coupling 14 between the handle and a ratchet 16 and having a ratchet head 18. A selector 20 is positioned on top of the ratchet, as well known to those skilled in the art.

In FIG. 1(a) a more detailed showing of the ratchet head is illustrated, particularly showing a mating shaft 22 for engagement with a tool, as well known to the art.

In FIG. 2 a similar device is shown except that the tool connected to the handle by the coupling 14 is a pry bar 24.

In FIG. 3 a pin useful in the adjustable tool of the present invention is shown. The pin comprises a pin 50 having a first end 52, a second end 54 and an outside 56. The pin also includes on its first end 52 on its outside, a first row 58 of splines. A first space 60 slightly wider than the first row 58 of splines is positioned next to the first row of splines. A second row of splines 62 is somewhat wider and is positioned adjacent to first space 60. A second space 64 is positioned adjacent to the edge of second row of splines 64 and adjacent to second end 54. The pin also includes two ball bearings 104 and 106, which in the assembled wrench are positioned in holes in the second row of splines and maintained in an outwardly biased position by springs positioned beneath the ball bearings in the holes, as known to the art. Desirably the holes are positioned in valleys between splines. First end 52 is shown as including a first row of splines 58 on its outside and on it's inside a recess 66, a bevel 68 and a screw receptacle 70.

In FIG. 3(b) an end view of second end 54 is shown and is similar to the end view of first end 52, except that the splines on the outside are the outside of the second row of splines 62.

End caps are typically used with the pin, with end caps being shown in FIG. 3(c). An end cap includes a protrusion 74, which mates with recess 66 and is formed for connection to the first and second ends by a screw (not shown) which is seated in a bevel 78 and positioned through a screw opening 76 into screw receptacle 70.

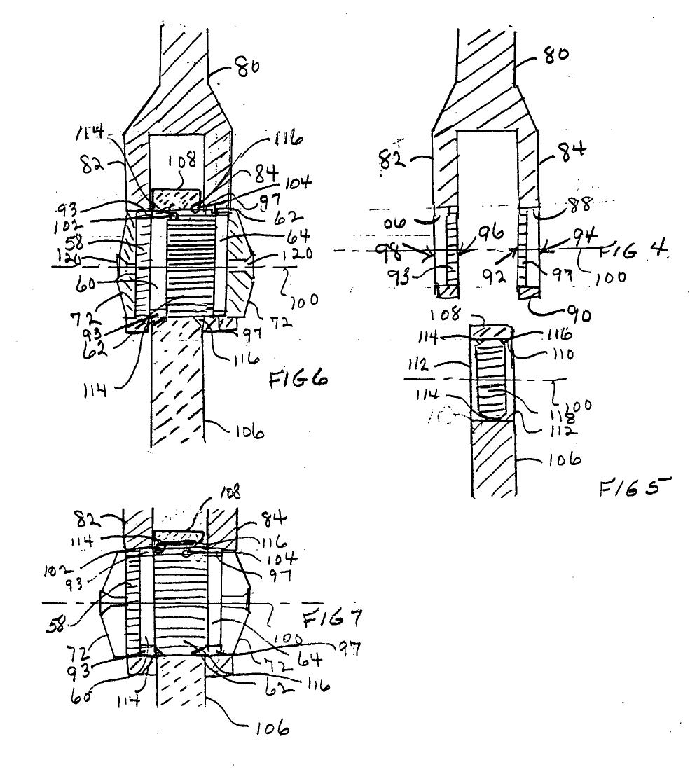

In FIG. 4 a first member 80 is shown and includes a first extension 82 and a second extension 84. These extensions are spaced to receive, between the extensions a second member 106. First member 80 includes first extension 82, including a first receptacle 86 and second extension 84, including a second receptacle 88. The receptacles are located in a first end 90 of the first member. First receptacle 86 has an inside circumference 92 with a first receptacle row of splines 93 being located on inside circumference 92. Outside circumference 94 of receptacle 86 is as shown. A second receptacle row of splines 97 is positioned on an inside circumference 96 of second receptacle 88. The receptacles have a common axis 100.

In FIG. 5 a second member 106 is included and is adapted to matingly engage first member 80. A second end of second member 108 includes a third receptacle 110, which has an inside circumference 112 and includes a first and a second bevel 114 and 116, respectively around its outer circumference on both sides of the third receptacle. Splines 118 are positioned on the middle portion of the circumference of third receptacle 110. When the coupling is formed, these members are positioned with the second end 108 of second member positioned with third receptacle 108 positioned coaxially with first and second receptacles 86 and 88.

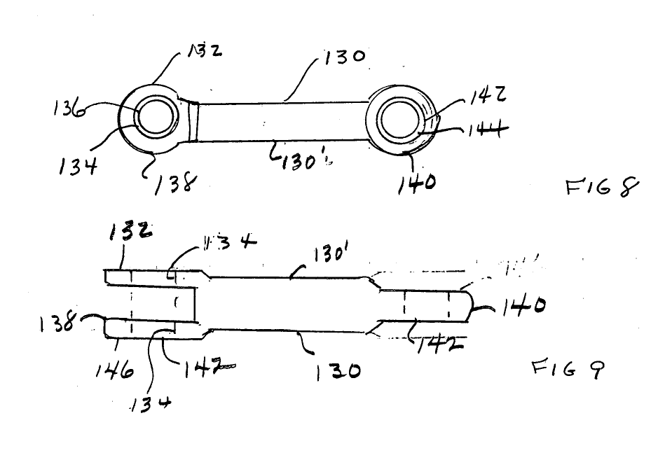

In FIG. 6 a pin, as previously described, is positioned through receptacles 86 and 88 and third receptacle 110. As shown in FIG. 6 ball bearing 104 is positioned in an outwardly extended position from second row of splines 62 in bevel 116. In this position, first receptacle row of splines 93 and second receptacle row of splines 97 are positioned in engagement with first row of splines 58 and second row of splines 62 on the pin. This ball bearing, which is desirably extended from about 50 to about 65 percent of its diameter outwardly from the receptacle in which it is positioned in the pin as now positioned in bevel 116 maintains the pin in this position. To change this positioning, the pin may be pushed through the receptacle until ball bearing 102 is positioned in bevel 114 in which position splined rows 93 and 97 are located in first space 60 and second space 64, as shown in FIG. 7. In this position, the wrench is released and the members can be rotated relative to each other. It will be noted that there is no significant protrusion of either of the sides of the pin from the outside of member 80. This pin arrangement does not require any springs for its operation.

Desirably the ball bearings are about 0.063 inches in diameter, although other sizes could be used, especially if larger pins are desired. Typically, the first row of splines 58 is approximately 0.063 inches in width with first space 60 being slightly wider so that splines 58 can rotate freely in space 60. Second space 64 is also of approximately the same diameter. Typically the ball bearings are positioned about 0.063 inches apart so that the rows of splines are readily moved from engagement into the bevels by simply pushing the pin through the coupling.

By the use of the adjustable tool of the present invention, there are no protruding members above or below the coupling and the coupling can be used in either a horizontal or a vertical position on a wrench or tool. As shown in FIG. 1 and FIG. 2, the coupling is clearly horizontal as positioned on the tool in FIG. 1 and is clearly vertical as positioned in the tool shown in FIG. 2.

In the embodiments shown in FIGS. 6 and 7, the ends are retained in position by screws 120. As also shown in FIGS. 1 and 2 the pin receptacles and all other receptacles are coaxially positioned. This connection is a very effective connection and is readily used to produce tools of any desired type. In other words, a handle can be attached to either the first or second member. Similarly a tool can be attached to either the first or the second member. It is immaterial whether the tool is attached to the member having the two receptacles or whether it is attached to member 106, which has a single shaft.

While substantially any coupling could be used which will allow for the adjustment of the multi-coupling containing wrench, as discussed above, it is preferred that a coupling such as discussed above which is positively moved to either a rotatable or a locked position be used. Further it is considered that couplings such as discussed above, since they do not require springs are somewhat more durable than couplings which do require springs and are somewhat less susceptible to damage than coupling which have protruding parts. In any event, Applicant is unaware of any wrenches which use a plurality of couplings to permit a selected configuration of the wrench to reach difficultly reachable areas for operation.

According to the present invention, such is accomplished with relative ease. It is clear that, as shown in FIG. 1, the handle and the wrench could be reversed since it is immaterial whether the two extension ends or the single extended member end of the link shown in FIG. 9 is used to engage the handle or the wrench. By the use of the multi-couplings, tailored tools can be produced to access almost any area for the performance of operations in the area.

FIGS. 8 and 9 show links suitable for use in the present invention. In FIG. 8 a top view of a suitable link is shown. The ends of the link are basically a top view of the cross-sectional ends shown in FIGS. 4 and 5. In link 130 a shaft or other suitable member 131 is shown connecting an extension 132, as previously referred to, including a receptacle 134, which includes splines 136 at a first end 138 of link 130. A second end 140, a second receptacle 142 is shown showing splines 144. The receptacles 134 and 142 can be used either for mating connection to a tool with a pin, as discussed above, or to another link. As also discussed previously, any suitable pin may be used which is suitable to releasably disengage and engage the connected members at a coupling.

FIG. 9 is a top view of the link shown in FIG. 8 and shows a top view of extension 132 and a second extension 146. These extensions are positioned at end 138 of link 130 and receptacles 134 are positioned through extensions 132 and 146, as discussed above. At second end 140, a receptacle 142 is shown. These links simply represent extensions of handle and tool linking material having ends as shown in FIGS. 4 and 5 in greater detail. These links are designed to matingly engage each other with a pin as discussed above positioned through the receptacles.

As discussed previously, any suitable pin arrangement can be used which is suitable to release the ends of the links from the mating connection to which they are linked for rotatable movement relative to the other pin and the like. Desirably, the pins used do not require springs or result in protrusions above the tops of the links. Clearly the links can be used either in a horizontal position of in a vertical position to extend the space between a tool handle and a tool. In many instances, a single or double link will be sufficient to achieve the desired configuration, although additional couplings could be used.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. An adjustable tool wherein a plurality of couplings and at least one link are positioned between the tool handle and the tool, the tool comprising:
a) a first member connected at a first coupling to a first link so that the first member and the first link are coupled to be rotatable relative to each other or so that the first member and the first link are locked relative to each other; and,
b) a second member connected to the first link at a second coupling so that the first link and the second member are rotatable relative to each other or so that the first link and the second member are locked relative to each other.

2. The tool of claim 1 wherein the first member is a handle and the second member is a tool.

3. The tool of claim 1 wherein first member is a tool and the second member is a handle.

4. The tool of claim 1 wherein the tool comprises a wrench.

5. The tool of claim 1 wherein the tool comprises a pry bar.

6. The tool of claim 1 wherein two couplings are included.

7. The tool of claim 1 wherein three couplings are used.

8. The tool of claim 1 wherein at least one additional link connected to the first link and at least one second coupling so that the first link and the at least one additional link are coupled to be rotatable relative to each other or so that the first link and the at least one additional link are locked relative to each other and a second member connected to the terminal link at a terminal coupling so that the terminal link and the second member are rotatable relative to each other or so that the terminal link and the second member are locked relative to each other.
